(19) United States
(12) Patent Application Publication
(10) Pub. No.: US 2015/0159948 A1
(43) Pub. Date: Jun. 11, 2015

(54) METHOD AND APPARATUS FOR CURING CANOLA

(71) Applicant: DARREN LARSON, Irma (CA)

(72) Inventor: DARREN LARSON, Irma (CA)

(21) Appl. No.: 14/099,671

(22) Filed: Dec. 6, 2013

(51) Int. Cl. F26B 3/00; F26B 21/10; F26B 21/08

(52) U.S. Cl. CPC F26B 3/00; F26B 21/08; F26B 21/10

(57) ABSTRACT

An apparatus and method are provided for curing canola. The canola is exposed to a temperature cycle with a period of 22 to 26 hours with the moisture content of the canola maintained at 11-13%. The curing process is carried out in a closed environment in a curing apparatus with an insulated exterior shell, an inner container to hold the canola, a humidifier and a heater. A blower is provided to circulate air in the apparatus, and the inner container includes means to provide movement of the canola.

### TECHNICAL FIELD

Canola seed curing.

### BACKGROUND

The presence of green canola seeds lowers the quality and price of a crop and poses a problem for growers when fields are harvested before the seed has fully matured or the field was unevenly ripe, or when weather conditions interfere, for example, frost or hot and dry conditions as the seeds near maturity. Immature green canola seeds contain chlorophyll that is fully degraded by enzymes as the seed matures and dries out, but remains if development is impeded. The percentage of green seed in a crop is considered to be fixed once canola seed is stored.

Currently, to reduce the amount of green seed, most growers swath the canola before harvest. After swathing, the canola seed is left in the swath to cure in the seed before combining. Many factors affect the length of time a seed needs to cure, the seed color change at the time of swathing, weather conditions and air temperature and humidity. Canola is cured and ready to harvest if both the green and moisture contents are low. The uniform moisture level must drop to 10% to be placed on the market to decrease the risk of deterioration and molding in storage. This process can take 10-14 days in ideal conditions and 3 or more weeks in cool or dry conditions. Leaving canola with less than 10% moisture increases the risk of seeds shelling in a strong wing, reducing the yield. Swathing over-ripe fields increases the risk of shattering pods leading to a loss of seeds.

Several problems face canola growers during the curing process. The enzymes that degrade chlorophyll require a specific temperature range and moisture to work. Hot conditions or a killing frost result in an overly rapid dry-down after swathing where the seed moisture level drops below 10% before it has had time to cure, lowering the quality of the crop. A light frost can fix the green color by damaging the enzymes and preventing additional clearing of chlorophyll.

### SUMMARY

A method of curing canola is disclosed comprising exposing canola to a cycle of temperatures while maintaining canola moisture content in a range of 11-13%, the cycle of temperatures ranging from a low temperature of the range 5-11° C. to a high temperature of the range 18-32° C. The cycle may approximate a day, for example may have a wavelength of 22-26 hours.

The air humidity may be increased or decreased for a period of time to increase or decrease a moisture content of the canola. The canola may be first stored in a bin.

An apparatus for curing canola is disclosed, comprising an exterior shell with at least one door, an inner container within the exterior shell, the inner container having air circulating holes and a mixing element and a blower, humidifier and heater within the exterior shell.

The exterior shell may be insulated. The mixing element may include a leveling auger. The mixing element may include a recirculating conveyor belt. The humidifier may be controlled by a humidistat and the heater may be controlled by a thermostat.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a graph showing a temperature cycle for curing canola;

FIG. 2 is a schematic diagram of a canola curing apparatus.

### DETAILED DESCRIPTION

Immaterial modifications may be made to the embodiments described here without departing from what is covered by the claims.

A crop of canola containing a percentage of green canola may be cured to higher quality canola after harvesting. Curing canola in a controllable environment allows a grower to lower the green content of a crop of canola to obtain a higher grade while avoiding losses due to frost and the potentially harmful effects of unpredictable weather conditions.

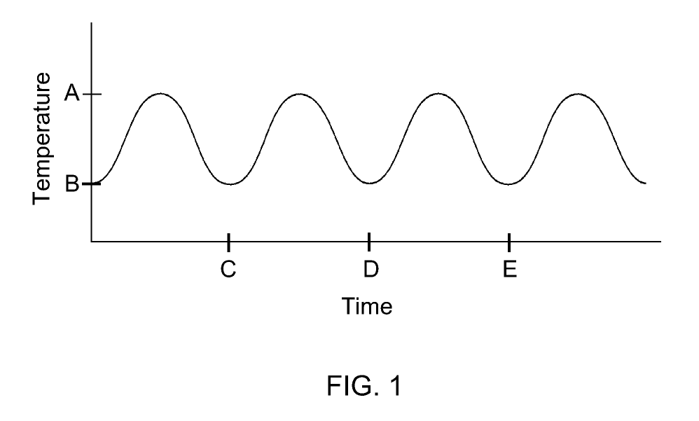

A method of curing canola includes exposing canola to a temperature cycle while maintaining the canola moisture content in a range of moisture content. Canola moisture content may be measured by a grain moisture sensor. The grain moisture sensor may be used directly on the canola during the process or used prior to treatment during an initial moisture content test and then the canola moisture content predicted by considering the effect of the treatment on the canola. Referring to FIG. 1, the temperature cycle has a period of approximately a day, preferably 22 to 26 hours. Points C, D and E mark the end of one full cycle and the beginning of the next. The temperature preferably cycles from a low temperature B in the range of 5 to 11° C. to a high temperature A in the range of 18 to 32° C. The length of time spent at or near the high and low temperatures in a cycle may be adjusted to speed up or slow down the curing process. More time at higher temperatures will speed up the curing process but also increase the risk of damage to the crop and the risk of fire. The canola moisture content is also preferably 11-13% to allow curing to occur while minimizing the risk of moisture-related damage to the crop. The air humidity may be adjusted to increase or decrease the moisture content of the canola. For example, higher air humidity levels may be used to rehydrate the canola seeds if the seed has already dehydrated to or below 11% moisture. The process may be carried out until the canola has reached a desired condition, for example 1-7 days. Three to four days may be sufficient in many cases depending on the starting point of the canola.

The temperature and moisture content ranges are set to minimize the risk of damage to the crop and for the safety of the grower. The parameters of heat, moisture content and time must be carefully controlled. Canola exposed to too much heat or moisture over time can lead to spoilage through heating and rotting. Stationary canola, or canola exposed to too high temperatures, may catch fire. To reduce the risks, air may be circulated and grain movement added, for example through stirring or other methods of mixing, during the curing process to reduce the risk of rotting. Clean air may be added to the curing environment while harmful gases are removed. Canola with high moisture content exposed to high heat, for example moisture content levels over 20% and temperatures over 35° C., will cure rapidly but be at risk of damage and fire if the moisture content and heat cannot be lowered quickly. High temperatures maintained over 25° C. must be managed carefully as the seeds lose moisture quickly at these temperatures and the curing process may become rapidly unmanageable and unsafe. Canola with low moisture content exposed to low temperature levels will result in a slow curing process. For efficiency, moisture content levels are over 10% and the low temperature is at or above 1° C. Cycling the temperature helps prevent against molding and spoilage. The parameters of the curing process adjusted for the kind of seed used and the starting moisture and green contents of the seeds. The levels of moisture content, temperature and time used may be adjusted inversely relative to each other to achieve similar results. For example, if lower temperatures are used, higher moisture content and longer time may be used, if lower moisture content levels are used, higher temperature and longer time may be used, and if a shorter time is used, higher moisture content and higher temperature may be used. The curing process may be ended by removing added heat and lowering the moisture content when the desired canola quality is achieved.

The canola may be stored in a bin after harvest for a length of time before the curing process. Canola that has been frozen may not cure as the enzyme that clears chlorophyll may have been damaged. Preferably, the canola seed has an initial moisture content over 10%, and an initial temperature at or above 1° C.

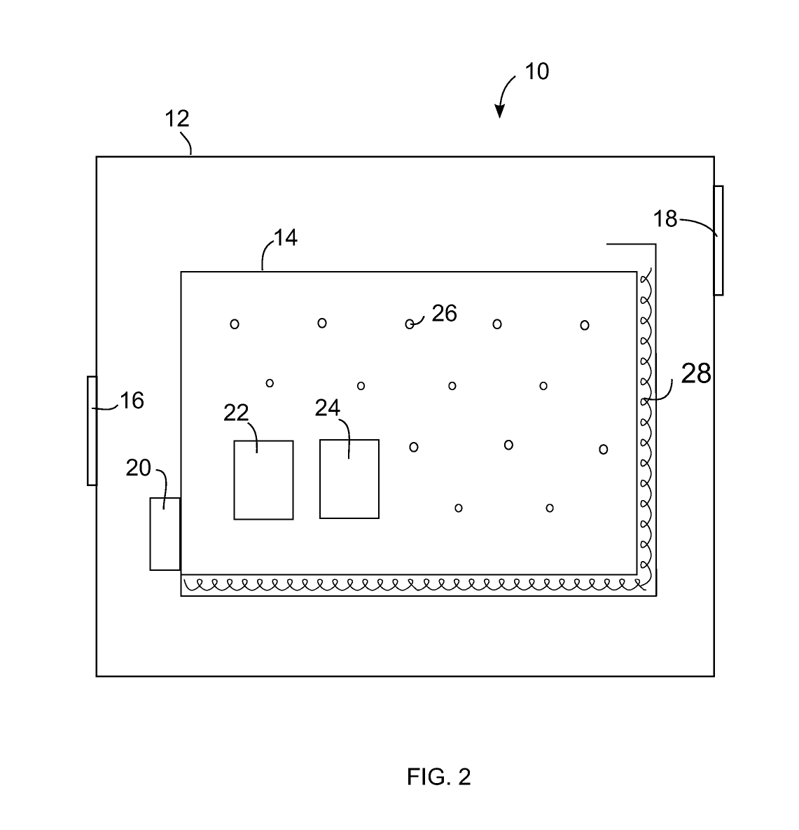

FIG. 2 shows an apparatus 10 for curing canola. The curing process is preferably carried out in a closed environment in order to control the moisture content of the canola, the air humidity and temperatures to which the canola is exposed. The apparatus 10 has an exterior shell 12, an inner container 14 with air circulating holes 26, a humidifier 22 and a heater 24. The humidifier 22 may be controlled by a humidistat with a sensor mounted in the canola. Heater 24 may be controlled by a thermostat with a sensor mounted in the canola, and may be a burner. A blower 20 may be used to circulate the air within the apparatus 10. Air circulating holes 26 may be provided to allow air to circulate around the canola. Inner container 14 holds the canola seed during the curing process and may have a leveling auger (not shown) at the top layer of the canola. A recirculating conveyor belt 28 may run along the bottom of and up a side of inner container 14 to provide grain movement during the curing process.

Exterior shell 12 is preferably insulated and sealed. At least one door is provided in the exterior shell. As shown in FIG. 2, intake door 16 and outfeed door 18 in the exterior shell are preferably closed during the curing process and may be opened after the curing process has completed. The doors 16 and 18 may be used during the curing process to modify the air humidity level or temperature within the exterior shell, or to introduce clean air and remove harmful gases.

Apparatus 10 may be modified from a circulating style grain dryer with a controllable heater and a controllable humidifier inside an insulated container. The canola moisture content and temperature levels used during the curing process may be frequently monitored and adjusted to maintain the desired levels. The process may eventually be automated.

Canola may be moved from a storage bin into the curing apparatus by an input conveyor belt and moved from the curing apparatus into a storage bin after the curing process is complete by an output conveyor belt.

The inventor tested the curing process within the ranges stated (varying temperature over 24 hours between 10° C. and 25° C., with canola moisture content 11-13%) and found an improvement in canola quality, and soundly predicts the treatment will work within and across the ranges as they do not deviate significantly from tested conditions.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A method of curing canola, comprising:
exposing canola to a cycle of temperatures while maintaining the canola moisture content in a range of 11-13%, the cycle of temperatures ranging from a low temperature of the range 5-11° C. to a high temperature of the range 18-32° C.;
where the cycle of temperatures has a wavelength of approximately a day.

2. The method of claim 1 in which the cycle of temperatures has a wavelength of 22-26 hours.

3. The method of claim 1 in which the canola is first stored in a bin.

4. The method of claim 1 further comprising increasing the air humidity for a period of time to increase a moisture content of the canola.

5. The method of claim 1 further comprising decreasing the air humidity for a period of time to decrease a moisture content of the canola.

6. An apparatus for curing canola, comprising:
an exterior shell with at least one door;
an inner container within the exterior shell, the inner container having air circulating holes and a mixing element; and
a blower, humidifier and heater within the exterior shell.

7. The apparatus of claim 6 wherein the exterior shell is insulated.

8. The apparatus of claim 6 wherein the mixing element includes a leveling auger.

9. The apparatus of claim 6 wherein the mixing element includes a recirculating conveyor belt.

10. The apparatus of claim 6 wherein the humidifier is controlled by a humidistat.

11. The apparatus of claim 6 wherein the heater is controlled by a thermostat.
